(19) United States
(12) Patent Application Publication
(10) Pub. No.: US 2026/0097592 A1
(43) Pub. Date: Apr. 9, 2026

(54) INKJET PRINTING APPARATUS, INKJET PRINTING METHOD, AND STORAGE MEDIUM

(71) Applicant: Konica Minolta, Inc., Tokyo (JP)

(72) Inventor: Harumitsu FUJIMORI, Tokyo (JP)

(21) Appl. No.: 19/352,545

(22) Filed: Oct. 8, 2025

(30) Foreign Application Priority Data
Oct. 9, 2024 (JP) 2024-177184

(51) Int. Cl. B41J 2/21; B41J 11/00

(52) U.S. Cl. CPC B41J 2/2139; B41J 2/2146; B41J 11/00214; B41J 11/0095

(57) ABSTRACT

An inkjet printing apparatus includes: a printing section that prints a color measurement chart including a color measurement patch and a position patch on a recording medium; a colorimeter that detects the color measurement chart; and a hardware processor. The hardware processor performs first control of making an ink adhesion amount to the position patch larger than an ink adhesion amount to the color measurement patch in printing of the color measurement chart.

### CROSS-REFERENCE TO RELATED APPLICATION

The entire disclosure of Japanese Patent Application No. 2024-177184, filed on October 9, 2024, including description, claims, drawings and abstract is incorporated herein by reference.

### BACKGROUND OF THE INVENTION

### TECHNICAL FIELD

The present invention relates to an inkjet printing apparatus, an inkjet printing method, and a storage medium.

### DESCRIPTION OF RELATED ART

There is known an image reading device that acquires parameters such as a position, an inclination, and a magnification of a color measurement image based on a reading result of a position measurement image (see Japanese Unexamined Patent Publication No. 2023-034825). The position measurement image is also referred to as a position patch.

On the other hand, in an inkjet printing apparatus, nozzle deficiency, which is a state in which ink is not ejected from a nozzle of a print head, may be a problem. In a case where the nozzle deficiency occurs, a white vertical streak extending in a sheet conveyance direction (FD direction) may occur due to dot omission. As illustrated in FIG. 1, in a case where a white vertical streak L overlaps a position patch 202, sensing of the position patch by an image reading device performed while the sheet is conveyed is not appropriately performed. Thus, stable color measurement cannot be performed. Note that the white vertical streak L in FIG. 1 is shown larger than an actually assumed width for the sake of description.

### SUMMARY OF THE INVENTION

The present invention has been made in view of the above-mentioned situations. A problem to be solved by the present invention is to provide an inkjet printing apparatus, an inkjet printing method, and a storage medium, which are capable of stable color measurement.

The above problem according to the present invention is solved by the following means.

According to one aspect of the present invention, an inkjet printing apparatus includes: a printing section that prints a color measurement chart including a color measurement patch and a position patch on a recording medium; a colorimeter that detects the color measurement chart; and a hardware processor, wherein the hardware processor performs first control of making an ink adhesion amount to the position patch larger than an ink adhesion amount to the color measurement patch in printing of the color measurement chart.

According to another aspect of the present invention, an inkjet printing method includes: chart printing in which a printing section prints a color measurement chart including a color measurement patch and a position patch on a recording medium; and color measuring in which a colorimeter detects the color measurement chart, wherein in the chart printing, a hardware processor performs first control to make an ink adhesion amount to the position patch larger than the ink adhesion amount to the color measurement patch.

According to another aspect of the present invention, a non-transitory computer readable storage medium includes a program that causes a computer of an inkjet printing apparatus including a printing section that prints a color measurement chart including a color measurement patch and a position patch on a recording medium, a colorimeter that detects the color measurement chart, and a computer, to perform, a first control to make an ink adhesion amount to the position patch larger than the ink adhesion amount to the color measurement patch in printing of the color measurement chart.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a diagram illustrating a color measurement chart in which a white streak occurs;

FIG. 2 is a schematic configuration diagram of an embodiment of an inkjet printing apparatus;

FIG. 3 is a block diagram illustrating a functional configuration of an embodiment of an inkjet printing apparatus;

FIG. 4 is a schematic configuration diagram of an embodiment of a colorimeter;

FIG. 5 is a view illustrating an example of the color measurement chart;

FIG. 6 is a flowchart illustrating an example of a process from printing to discharge of the color measurement chart;

FIG. 7 is a flowchart illustrating an example of a detailed flow of a CD position patch detection operation;

FIG. 8 is a flowchart illustrating an example of a detailed flow of a color measurement operation;

FIG. 9 is a flowchart illustrating an example of a flow of a normal job;

FIG. 10 is a flowchart illustrating an example of a flow of a color measurement job;

FIG. 11 is a diagram illustrating a portion of the color measurement chart printed based on a first processing;

FIG. 12 is a diagram illustrating a portion of the color measurement chart printed based on the first processing;

FIG. 13 is a diagram illustrating a portion of the color measurement chart printed based on the first processing;

FIG. 14 is a diagram illustrating a portion of the color measurement chart printed based on the first processing;

FIG. 15 is a diagram schematically illustrating ink dots with respect to a dot region in a color measurement patch;

FIG. 16 is a diagram schematically showing the ink dots with respect to the dot region in a position patch;

FIG. 17 is a diagram schematically showing the ink dots with respect to the dot region in the position patch;

FIG. 18 is a diagram illustrating the position patch in which an ink adhesion amount is increased with respect to an entire region;

FIG. 19 is a diagram illustrating the position patch in which the ink adhesion amount is increased with respect to only edge regions on four sides;

FIG. 20 is a diagram illustrating the position patch in which the ink adhesion amount is increased only in edge regions on both sides in a recording medium conveyance direction; and

FIG. 21 is a diagram illustrating the position patch in which the ink adhesion amount is increased only in edge regions on a front side in the recording medium conveyance direction.

### DETAILED DESCRIPTION

Hereinafter, one or more embodiments of the present disclosure will be described with reference to the drawings. However, the scope of the invention is not limited to the disclosed embodiments.

The following description will describe one or more embodiments of the present invention with reference to the drawings. The effects and features of the embodiments of the present invention will be understood from the following detailed description and the drawings. The following detailed description and drawings are provided for illustration only and do not limit the scope of the present invention.

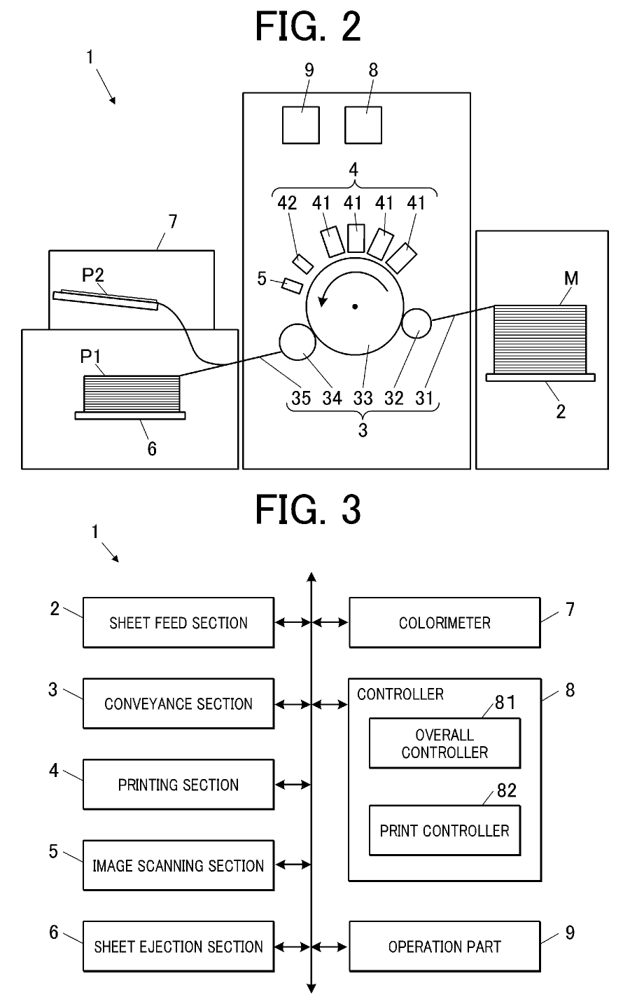

FIG. 2 is a schematic configuration diagram of an embodiment of an inkjet printing apparatus 1 of the present invention. FIG. 3 is a block diagram illustrating a functional configuration of an embodiment of the inkjet printing apparatus 1 of the present invention.

As shown in FIG. 2 and FIG. 3, the inkjet printing apparatus 1 may include a sheet feed section 2, a conveyance section 3, a printing section 4, an image scanning section 5, a sheet ejection section 6, a colorimeter 7, a controller 8 (hardware processor), and an operation part 9.

The sheet feed section 2 stores a recording medium M. The sheet feed section 2 includes, for example, a tray. Examples of the recording medium M include printing sheet, textile, and sheet-like resin. Examples of a printing sheet include plain paper and coated paper.

As illustrated in FIG. 2, a conveyance section 3 includes, for example, a feeder board 31, a first handover drum 32, a conveyance drum 33, a second handover drum 34, and a carrying-out section 35.

The feeder board 31 conveys the recording medium M from the sheet feed section 2 to the first handover drum 32. The first handover drum 32 holds one end of the recording medium M conveyed by the feeder board 31, picks up the recording medium M, and passes over the recording medium M to the conveyance drum 33.

The conveyance drum 33 has, for example, a columnar shape. A side circumferential surface of the conveyance drum 33 is a conveyance surface that attracts and holds the recording medium M. The conveyance drum 33 rotates in one direction around a central axis as a rotation axis in a state of holding the recording medium M on the conveyance surface. Thus, the conveyance drum 33 conveys the recording medium M, which is attracted to and held by the conveyance surface, along the conveyance surface.

The printing section 4 may include, for example, one or a plurality of head units 41. The printing section 4 performs a print job for producing a printed material by an inkjet method. Each of the head unit 41 includes one or a plurality of inkjet heads. The head unit 41 may have an ink ejection face at a position facing the conveyance surface of the conveyance drum 33. The head unit 41 forms an image by ejecting ink onto the recording medium M held by the conveyance drum 33 at appropriate timings corresponding to arotation of the conveyance drum 33, thereby producing the printed material P. The ink is not particularly limited, but for example, an ultraviolet curable ink is used.

In the inkjet printing apparatus 1 illustrated in FIG. 2, four head units 41 are arranged at predetermined intervals in order from an upstream side in a rotation direction of the conveyance drum 33. The four head units 41 correspond to inks of four colors, for example, yellow, magenta, cyan, and black, respectively. The printing method is not limited, but is, for example, a single-pass method. The single-pass method is a method in which printing is performed in one pass by one or a plurality of head units 41 that cover an entire region in a width direction of the recording medium M. In the inkjet printing apparatus of the related art, a white vertical streak is likely to occur in a case where a nozzle deficiency occurs in the single pass method. However, in the inkjet printing apparatus of the present invention, white vertical streaks are less likely to occur even in the single-pass method, due to first control described later.

The printing section 4 may include an ultraviolet irradiation section 42 downstream of the head unit 41 in the conveyance direction. In a case where the ink is ultraviolet curable ink, the ink on the recording medium M can be cured by the ultraviolet irradiation section 42 emitting ultraviolet rays.

The printing section 4 performs print jobs such as a normal job and a color measurement job. A normal job is a print job for creating a normal printed material P1 that is not to be a target of color measurement. The color measurement job is a print job for producing a color measurement chart printed material P2 on which a color measurement chart is printed.

In order to read information on the presence or absence of a defect of the printed material P, a nozzle deficiency position, and the like, the image scanning section 5 irradiates the printed material with light from a light source and reads a reflected image thereof. The image scanning section 5 is composed of, for example, an in-line sensor in which a plurality of detection elements are arranged along a direction (width direction) orthogonal to the conveyance direction of the printed material. Data of the image read by the image scanning section 5 is sent to, for example, the controller 8.

The second handover drum 34 holds one end of the printed material P conveyed by the conveyance drum 33, picks up the printed material P, and hands over the printed material P to the carrying-out section 35.

The carrying-out section 35 is a carrying-out path of the printed material, and conveys the printed material to the sheet ejection section 6 or the colorimeter 1. To be specific, the carrying-out section 35 conveys normal printed material P1 produced by the normal job to the sheet ejection section 6, and conveys color measurement chart printed material P2 produced by the color measurement job to the colorimeter 7. The carrying-out section 35 is formed of, for example, a belt, a roller, and the like. The conveyance route in the carrying-out section 35 may be branched in the middle as illustrated in FIG. 2. The sheet ejection section 6 includes, for example, a tray.

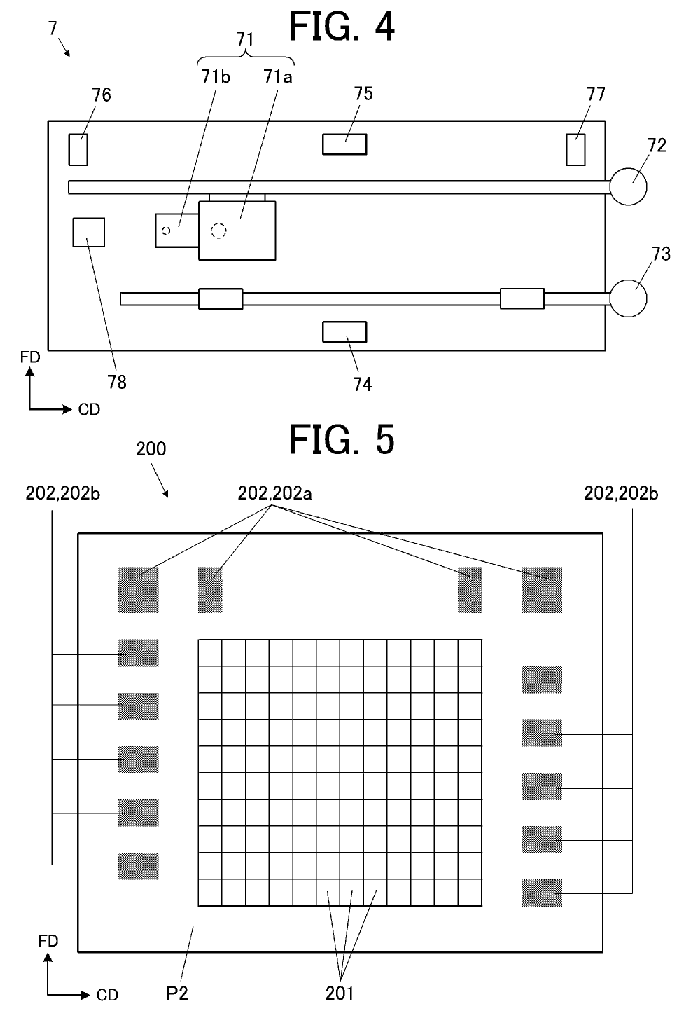

The colorimeter 7 is a device that detects a color measurement chart 200, and can be arranged in-line in the inkjet printing apparatus 1. FIG. 4 is a configuration diagram illustrating an example of the colorimeter 7. As illustrated in FIG. 4, the colorimeter 7 includes, for example, a color measurement head 71, a first motor 72, a second motor 73, a sheet leading edge sensing sensor 74, a sheet trailing edge sensing sensor 75, a left home sensor 76, a right home sensor 77, and a white calibration plate 78. The color measurement head 71 includes a color measurement sensor 71a and a position sensor 71b. The color measurement sensor 71a optically detects and performs color measurement on color measurement patches. The color measurement is to measure color information, and for example, is to measure a color value such as L * a * b * value, etc.. As the color measurement sensor 71a, for example, a spectral colorimeter that spectrally disperses reflected light from the color measurement patch and performs color measurement can be used. The sensor 71b detects the position patch. The position sensor 71b is mechanically attached adjacent to the color measurement sensor 71a, for example, and is movable together with the color measurement sensor 71a. The first motor 72 is driven to move the color measurement head 71 in a main scanning direction (CD direction, cross direction) back and forth. The second motor 73 is driven to convey the color measurement chart printed material P2 in a sub-scanning direction (FD direction, Feed Direction) orthogonal to the main scanning direction. The sheet leading edge sensing sensor 74 and the sheet trailing edge detection sensor 75 detect a leading edge and a trailing edge of the color measurement chart printed material P2, respectively. The left home sensor 76 and the right home sensor 77 respectively detect left and right limit positions when the color measurement sensor 71a is moved. The white calibration plate 78 is used for calibrating the color measurement sensor 71a.

The position sensor 71b is preferably a single-wavelength reflective fiber optic sensor or a reflective color sensor. In a single-wavelength reflective optical fiber sensor or a reflective color sensor, the difference between the light reception amount in a white region and the light reception amount in a black region is different depending on the distance to a position patch that is a detection target. Specifically, as the distance to the position patch decreases, the difference between the light reception amount in the white region and the light reception amount in the black region increases, and the sensitivity improves. On the other hand, in a case where the distance between the position sensor 71b and the position patch is small, since the sensing range is narrow, the sensing range is likely to be affected by the white vertical streak due to the nozzle deficiency. However, in the present invention, the white vertical streak is less likely to be generated by the first control described later, and thus the distance between the position sensor 71b and the position patch can be shortened. Therefore, by using the reflection type optical fiber sensor or the reflection type color sensor with the single wavelength, sensitivity can be improved when the distance between the position sensor 71b and the position patch is reduced, and more stable color measurement can be performed.

The controller 8 controls operation of the other functional components in accordance with print image data, print setting, and the like. The controller 8 is a computer, and includes, for example, a central processing unit (CPU), a RAM (Random Access Memory), and a ROM (read only memory). The CPU executes various control programs to drive and control the inkjet printing apparatus 1 and performs various calculation processes. The RAM provides a working memory space for the CPU and stores temporary data. The RAM may include a nonvolatile memory. The ROM stores various control programs to be executed by the CPU, setting data, and the like. Instead of the ROM, a rewritable nonvolatile memory such as a flash memory may be used. The controller 8 can perform the first control described later. The controller 8 may include an overall controller 81 to perform overall control of the inkjet printing apparatus 1 and a print controller 82 to control the printing operation and perform image processing.

The overall controller 81 may be an external device including, for example, a computer of a client. The overall controller 81 generates print data based on a print job such as a normal job or a color measurement job. Specifically, the overall controller 81 generates the print data by performing, on the image data, raster image processor (RIP) processing to convert the image data into a raster image, color correction, and conversion into a bitmap format that is a printable format. The generated print data is transmitted to, for example, the print controller 82. Note that the print data does not necessarily have to be data generated by the overall controller, and may be data saved in advance. The overall controller 81 can also perform control for executing a print job, purge processing for conveying the color measurement chart printed material P2 to the colorimeter 7 instead of the sheet ejection section 6, and the like.

For example, under the control of the overall controller 81, the print controller 82 controls the operations of the conveyance section 3, the printing section 4, the image scanning section 5, and the like, and produces the printed material P. Specifically, the print controller 82 performs determination of an ink ejection amount, image processing, color measurement data processing, head unit driving control, ultraviolet irradiation control, conveyance control, determination of an ink ejection method, determination of an ink amount limit value, acquisition of nozzle deficiency information, acquisition of sheet type information, and the like, and the printed material is produced.

The operation part can be used when a user inputs various settings for printing, information for creating an ICC profile, and the like.

FIG. 5 is a view illustrating an example of the color measurement chart 200. The color measurement chart 200 illustrated in FIG. 5 as an example includes a plurality of color measurement patches 201 and a plurality of position patches 202.

The plurality of color measurement patches 201 form a plurality of columns arranged in the CD direction and a plurality of rows arranged in the FD direction. The foremost row among the plurality of rows is the first row. The front side is a front side in the conveyance direction of the color measurement chart printed material P2. The plurality of position patches 202 include a CD-position patch 202a whose main purpose is to indicate position information in the CD-direction and a FD-position patch 202b whose main purpose is to indicate position information in the FD-direction.

The plurality of CD-position patches 202a are positioned aligned in a state of being separated from each other in the CD-direction on the front side relative to the color measurement patch 201.

The plurality of FD position patches 202b are positioned aligned in a state of being separated from each other in the FD direction on one or both of the left and right sides of the color measurement patch 201. Each FD position patch 202b is positioned so that the position in the FD direction coincides with each row of the color measurement patch 201. To be more specific, each FD position patch 202b arranged in the FD direction on the left side of the color measurement patch 201 is positioned so that the position in the FD direction coincides with each row of the odd-numbered rows of the color measurement patch 201. The FD position patches 202b arranged in the FD direction on the right side of the color measurement patch 201 are positioned so that the positions thereof in the FD direction coincide with each row of the even-numbered rows of the color measurement patch 201. In the present invention, the "left side" refers to the left side facing the conveyance direction of the color measurement chart printed material P2. The "right side" refers to the right side when facing the conveyance direction of the color measurement chart printed material P2.

The above description is a description of the color measurement chart 200 illustrated in FIG. 5, and does not limit the color measurement chart 200 according to the present invention.

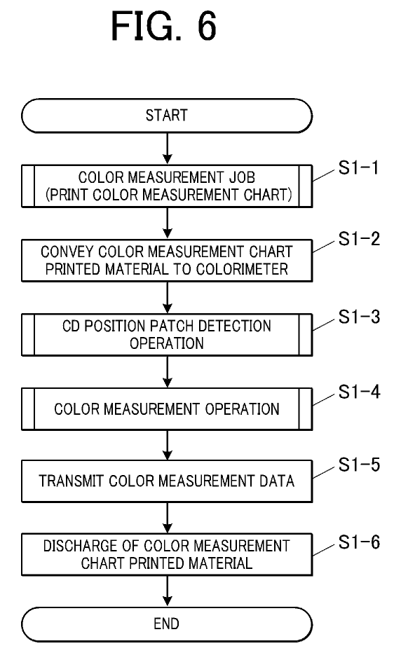

FIG. 6 is a flowchart illustrating an example of a flow from printing to discharge of the color measurement chart 200. In step S1-1, the printing section 4 creates a color measurement chart printed material P2. In step S1-2, the conveyance section 3 transports the color measurement chart printed material P2 to the colorimeter 7. In step S1-3, the colorimeter 7 performs a CD-position patch detection operation. In step S1-4, the colorimeter 7 executes a color measurement operation. In step S1-5, the colorimeter 7 transmits the color measurement data to the print controller 82. In step S1-6, the colorimeter 7 discharges the color measurement chart printed material P2.

Although not illustrated in the flowchart of FIG. 6, the print controller 82 may transmit the received color measurement data to the overall controller 81. The overall controller 81 may execute control relating to print image adjustment such as color calibration and ICC profile creation based on the obtained color measurement data. The transmission of the color measurement data to the print controller 82 (step S1-5) may be performed every time the color measurement of each color measurement patch 201 is performed, every time the color measurement operation of the color measurement target row is completed, or collectively performed after the color measurement of all the color measurement patches 201.

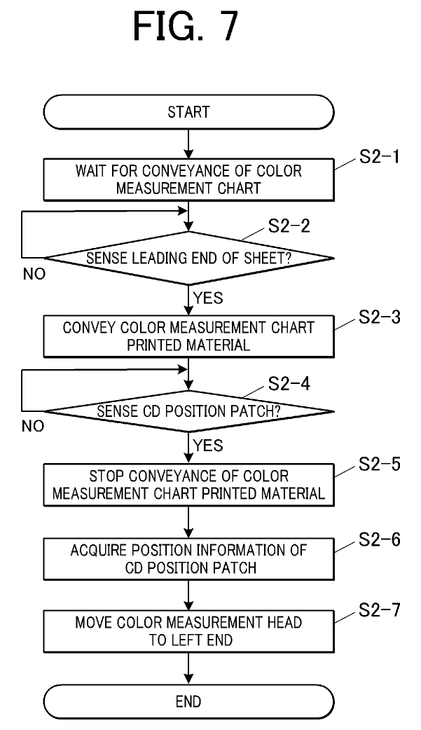

FIG. 7 is a flowchart illustrating an example of a detailed flow of the CD-position patch detection operation (step S1-3). In step S2-1, the first motor 72 moves the color measurement head 71 in the CD-direction in a position so that the position sensor 71b can detect the CD-position patch 202a at the left end, and waits for the color measurement chart printed material P2 to be conveyed. When the leading edge of the color measurement chart printed material P2 conveyed by the sheet leading edge sensing sensor 74 in step S2-2 is sensed, the flow proceeds to step S2-3. In step S2-3, the second motor 73 is driven to continue the conveyance of the color measurement chart printed material P2 in the FD direction. When the position sensor 71b senses the left end of the CD-position patch 202a in step S2-4, the flow advances to step S2-5. In step S2-5, the second motor 73 stops conveyance of the color measurement chart printed material P2. In step S2-6, the first motor 72 moves the color measurement head 71 from the left end to the right end, and at this time, the position sensor 71b acquires the position information of each CD-position patch 202a. The size, the color measurement timing, and the like of the colorimetric patch 201 are calculated from the position information of each of the CD-position patches 202a, and the calculated values are held for the subsequent color measurement operation. In step S2-7, the first motor 72 moves the color measurement head 71 to the left end in the CD-direction until the position sensor 71b reaches a position capable of detecting the left side of the FD position patch 202b, and stops the color measurement head 71.

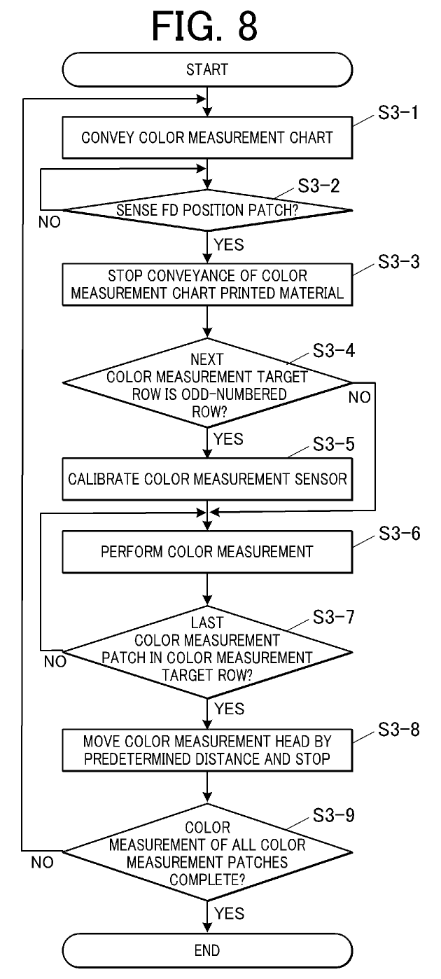

FIG. 8 is a flowchart illustrating an example of a detailed flow of the color measurement operation (step S1-4). In step S3-1, the second motor 73 is driven to convey the color measurement chart printed material P2 in the FD direction. When the position sensor 71b senses the FD position patch 202b of the conveyed color measurement chart printed material P2 in step S3-2, the flow advances to step S3-3. In step S3-3, the second motor 73 stops conveyance of the color measurement chart printed material P2. In step S3-4, it is determined whether the next colorimetry target row is an odd-numbered row. In a case where the next colorimetry target row is an odd-numbered row, the flow proceeds to step S3-5. In step S3-5, the color measurement sensor 71a is moved to the white calibration plate 78 and calibrated. In step S3-6, the color measurement sensor 71a performs color measurement on each color measurement patch 201 while moving in the CD-direction. The movement direction of the color measurement sensor 71a at this time is from left to right when the color measurement target row is the odd-numbered row, and is from right to left when the color measurement target row is the even-numbered row. In a case where it is determined in step S3-7 that the color measurement is performed on the final color measurement patch 201 of the color measurement target row, the flow proceeds to step S3-8. In step S3-8, the measurement head 71 is moved by a predetermined distance in the CD-direction and then stopped. When it is determined in step S3-9 that the color measurement of all the color measurement patches 201 has been completed, the flow ends. When it is not determined that the color measurement of all the color measurement patches 201 has been completed, the flow returns to step S3-1.

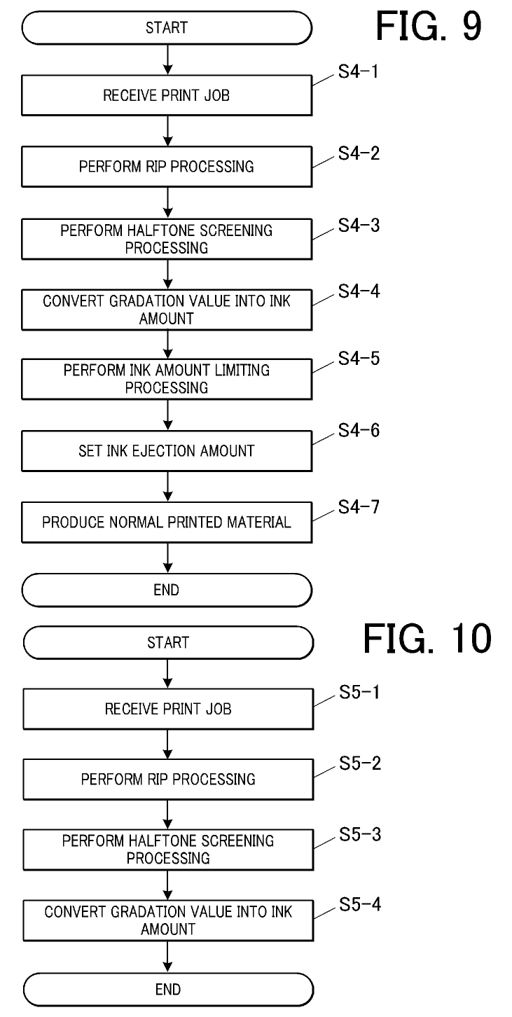

FIG. 9 is a flowchart illustrating an example of the flow of the normal job. In step S4-1, the controller 8 receives the print job and acquires the image data to be printed. In step S4-2, the controller 8 performs RIP processing on the acquired image data to convert the RGB data into CMYK data. In step S4-3, the controller 8 performs a halftone screening process on each color data, and converts binary data into, for example, a 256 tone value. In step S4-4, the controller 8 converts a gradation value into an ink amount to be discharged, for example, the ink amount of five levels. In step S4-5, the controller 8 performs an ink amount limiting process. In step S4-6, the controller 8 sets an ink ejection method. In step S4-7, the printing section 4 produces the normal printed material P1 under the control of the controller 8.

FIG. 10 is a flowchart illustrating an example of a flow of a color measurement job. In step S5-1, the controller 8 receives an instruction to perform a color measurement operation, and acquires the print data of the color measurement chart 200 generated in advance. The controller 8 also acquires sheet type information and the like of the recording medium M. In step S5-2, the controller 8 grasps a region in which the position patch 202 is printed in the print data of the color measurement chart 200. In step S5-3, the controller 8 performs the first control in which an ink adhesion amount to the position patch 202 is made larger than the ink adhesion amount to the color measurement patch 201. In step S5-4, the printing section 4 creates the color measurement chart printed material P2 on the basis of the control including the first control by the controller 8.

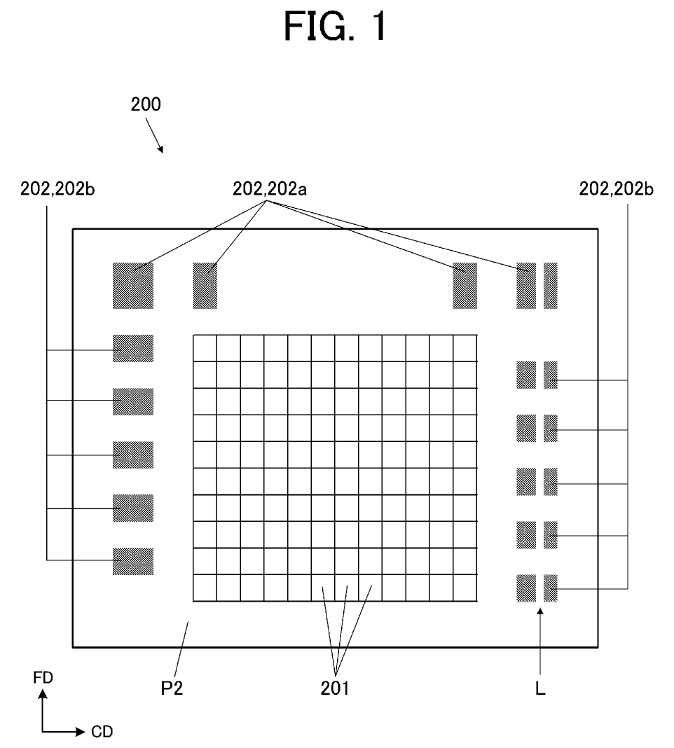

As described above, in the inkjet printing apparatus of the related art, the white vertical streak L as illustrated in FIG. 1 may occur due to the nozzle deficiency. In a case where the white vertical streak L overlaps the position patch 202, it becomes difficult to appropriately perform sensing of the position patch 202, and stable color measurement cannot be performed. As a countermeasure therefor, conventionally, when a state in which ink is not ejected from the nozzle occurs, a nozzle deficiency position is detected, and then "nozzle deficiency correction" is performed in which dot data to be originally printed but was not printed due to nozzle deficiency is distributed to peripheral nozzles for correction. If the nozzle deficiency correction is appropriately performed, the white vertical streak L is less likely to occur. However, since the nozzle deficiency may occur suddenly, it is difficult to always perform appropriate nozzle deficiency correction. In contrast, in the inkjet printing apparatus 1 according to the present invention, the ink adhesion amount to the position patch 202 is larger than the ink adhesion amount to the color measurement patch 201 by the first control. Thus, even if a nozzle deficiency occurs in a nozzle that ejects ink to the position patch 202, the white vertical streak L is less likely to occur in the position patch 202. Therefore, stable color measurement can be performed in the inkjet printing apparatus 1 of the present invention.

In the inkjet printing apparatus 1 of the present invention, even in a case where the nozzle deficiency occurs in the nozzle which discharges the ink to the position patch 202, the white vertical streak is less likely to occur in the position patch 202 by the first control. For this reason, the inkjet printing apparatus 1 of the present invention may not detect the nozzle deficiency position before the first control.

The controller 8 may perform the first control by setting an ink dot diameter in the position patch 202 to be larger than the ink dot diameter in the color measurement patch 201. The controller 8 may perform the first control by ejecting ink a plurality of times from the same nozzle to the same position in printing the position patch 202. The controller 8 may perform the first control by ejecting two or more colors of ink to the same position in printing of the position patch 202. The controller 8 may perform the first control by relaxing an ink amount limit value in printing of the position patch 202.

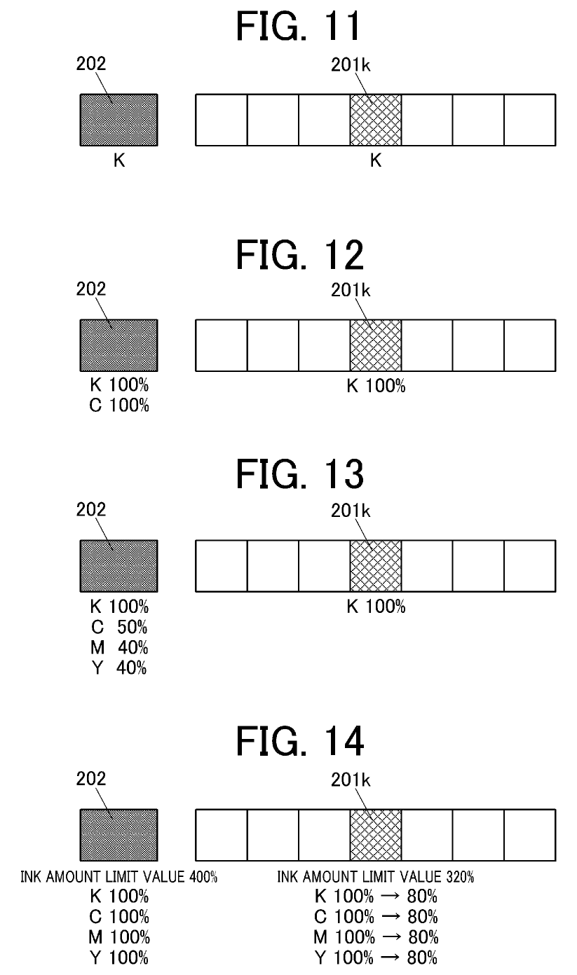

FIG. 11 to FIG. 14 illustrate respective parts of the color measurement charts 200 printed on the basis of first processing, in which the position patches 202 and the color measurement patches 201 are aligned. The color measurement patch 201k is one of the plurality of color measurement patches 201.

In FIG. 11, the position patch 202 and the color measurement patch 201k are printed in a single color of black (K). Here, the ink adhesion amount to the position patch 202 is larger than the ink adhesion amount to the color measurement patch 201k.

In FIG. 12, the position patch 202 and the color measurement patch 201k are printed in a color of black (K). Assuming that the maximum value of a black solid is 100%, the color measurement patch 201k is printed in K100%, whereas the position patch 202 is printed in black by K100% + C100%. Thus, the ink adhesion amount to the position patch 202 is larger than the ink adhesion amount to the color measurement patch 201k.

In FIG. 13, the position patch 202 and the color measurement patch 201k are printed in the color of black (K). Assuming that the maximum value of a black solid is 100%, the color measurement patch 201k is printed in K100%, whereas the position patch 202 is printed in black by K100% + C50% + M40% + Y40%. Thus, the ink adhesion amount to the position patch 202 is larger than the ink adhesion amount to the color measurement patch 201k.

In FIG. 14, the position patch 202 and the color measurement patch 201k are printed in the color of black (K). Here, the ink amount limit value of the color measurement patch 201k is limited to 320% (K80% + C80% + M80% + Y80%), whereas the ink amount limit value of the position patch 202 is relaxed to 400%. Thus, the ink adhesion amount to the position patch 202 is larger than the ink adhesion amount to the color measurement patch 201k.

FIG. 15 to FIG. 17 are diagrams for explaining a control example in which the ink dot diameter in the position patch 202 is made larger than the ink dot diameter in the color measurement patch 201.

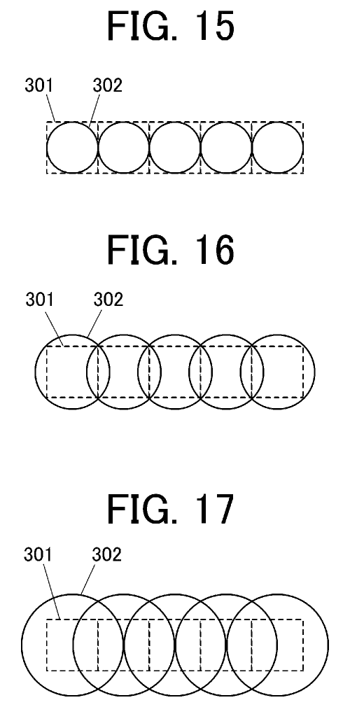

FIG. 15 schematically illustrates an ink dot 302 with respect to a dot region 301 in the color measurement patch 201. FIG. 16 schematically illustrates the ink dot 302 with respect to the dot region 301 in the position patch 202. In this example, as illustrated in FIG. 15, the ink dot 302 in the color measurement patch 201 fall within the dot region 301. In contrast, as shown in FIG. 16, the ink dot 302 in the position patch 202 protrudes into the adjacent dot region 301. That is, the ink dot diameter in the position patch 202 is larger than the ink dot diameter in the color measurement patch 201.

FIG. 17 illustrates an example in which the ink dot diameter in the position patch 202 is larger than that in FIG. 16. In FIG. 17, the ink dot 302 protrudes from half or more of the adjacent dot region 301. In this case, even when the nozzle deficiency corresponding to one dot occurs, the ink is complemented from the adjacent dot region 301. In other words, even when the nozzle deficiency position is not detected before the first control, it can be said that the nozzle deficiency correction is performed.

The ink dot diameter can be increased by, for example, increasing the amount of ink ejected in one ink ejection, or discharging ink a plurality of times from the same nozzle to the same position.

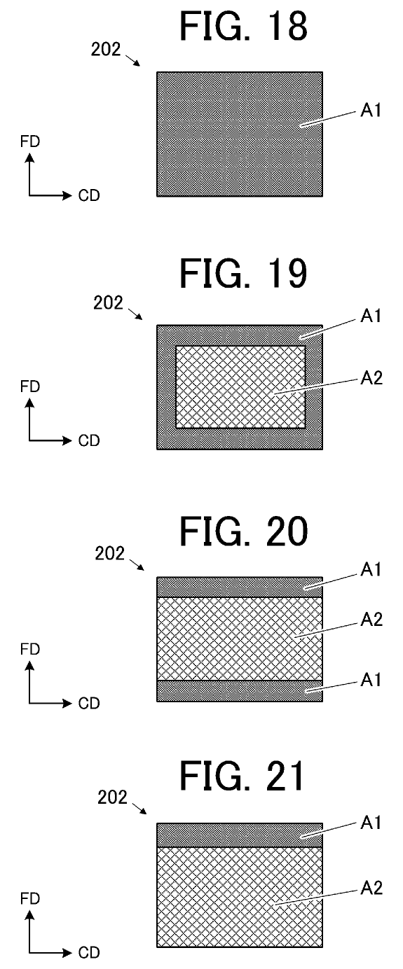

FIG. 18 to FIG. 21 illustrate the region A1 where the ink adhesion amount is made large by the first control and the region A2 where the ink adhesion amount is not made large in the position patch 202.

As illustrated in FIG. 18, the controller 8 may set the ink adhesion amount to be larger than the ink adhesion amount to the color measurement patch 201 over the entire area of the position patch 202 in the first control.

As illustrated in FIG. 19, in the first control, the controller 8 may set the ink adhesion amount to be larger than the ink adhesion amount to the color measurement patch 201 only for the edge region on the four sides of the position patch 202. Thus, the amount of ink to be used can be reduced. In this case, the ink adhesion amount to the region other than the edge region on the four sides may be the same as the ink adhesion amount to the color measurement patch 201. The "edge region" refers to, for example, a region within a range of a certain distance from an end of the position patch 202. The distance from the end of the position patch 202, which is the range of the edge region, can be freely determined to be, for example, equal to or smaller than the spot diameter of the position sensor 71b. The spot diameter of the sensor 71b is a diameter of a detection range on the sheet surface by the sensor 71b, and is, for example, 2 to 3 mm.

As illustrated in FIG. 20, in the first control, the controller 8 may set the ink adhesion amount to be larger than the ink adhesion amount to the colorimetric patch 201 only for the edge regions on both sides of the position patch 202 in the recording medium conveyance direction (FD direction). Thus, the amount of ink to be used can be further reduced. In this case, the ink adhesion amount to regions other than the edge regions on both sides in the recording medium conveyance direction (FD direction) can be the same as the ink adhesion amount to the color measurement patch 201.

As illustrated in FIG. 21, in the first control, the controller 8 may set the ink adhesion amount to be larger than the ink adhesion amount to the colorimetric patch 201 only for the edge region on the front side of the position patch 202 in the recording medium conveyance direction (FD direction). Thus, the amount of ink to be used can be further reduced. In this case, the ink adhesion amount to the region other than the edge region on the front side in the recording medium conveyance direction (FD direction) can be the same as the ink adhesion amount to the color measurement patch 201.

The controller 8 may perform the first control in the printing of the color measurement chart 200 performed during the normal job or between consecutive normal jobs. Printing of the color measurement chart 200 during the normal job or between consecutive normal jobs is more required not to fail because the normal job starts immediately afterwards. Therefore, the first control is more effective in printing of the color measurement chart 200 performed at such timing. Note that the present invention is not limited to this, and the controller may perform the first control, for example, in printing of the color measurement chart 200 performed before start of the normal job.

The controller may change the amount of increase in the ink adhesion amount to the position patch 202 relative to the ink adhesion amount to the color measurement patch 201 in the first control according to the type of the recording medium M. In a case where the recording medium M is a printing sheet, the controller may change the amount of increase in the ink adhesion amount to the position patch 202 relative to the ink adhesion amount to the color measurement patch 201 in the first control according to the sheety type of the printing sheet. Thus, considering that the shape of the ink dot 302 formed on the recording medium M varies depending on the type of the recording medium M and, in the case where the recording medium M is printing sheet, the sheet type of the printing sheet, it becomes easier to appropriately adjust the amount of increase in the amount of ink adhesion.

### Inkjet Printing Method

The inkjet printing method of the present invention includes a chart printing step and a color measurement step. In the chart printing step, the printing section 4 prints the color measurement chart 200 including the color measurement patch 201 and the position patch 202 on the recording medium M. In the chart printing step, the controller 8 performs the above-described first control. In the color measurement step, the colorimeter 7 detects the color measurement chart 200 printed on the recording medium M.

### Program

A program according to the present invention is a program that causes a computer included in the inkjet printing apparatus 1 described above to function as the controller 8 that performs the first control described above.

According to the present invention, it is possible to provide an inkjet printing apparatus, an inkjet printing method, and a storage medium which are capable of stable color measurement.

The foregoing description and drawings are merely illustrative of embodiments of the present invention and are not intended to limit the scope of the present invention. The scope of the present invention is to be interpreted by the scope of the claims.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An inkjet printing apparatus comprising:
a printing section that prints a color measurement chart including a color measurement patch and a position patch on a recording medium;
a colorimeter that detects the color measurement chart; and
a hardware processor,
wherein the hardware processor performs first control of making an ink adhesion amount to the position patch larger than an ink adhesion amount to the color measurement patch in printing of the color measurement chart.

2. The inkjet printing apparatus according to claim 1, wherein the hardware processor performs the first control by making an ink dot diameter in the position patch larger than an ink dot diameter in the color measurement patch.

3. The inkjet printing apparatus according to claim 1, wherein a nozzle deficiency position is not detected before the first control.

4. The inkjet printing apparatus according to claim 1, wherein the hardware processor performs the first control by ejecting ink a plurality of times from the same nozzle to the same position in printing of the position patch.

5. The inkjet printing apparatus according to claim 1, wherein the hardware processor performs the first control by ejecting two or more colors of ink to the same position in printing of the position patch.

6. The inkjet printing apparatus according to claim 1, wherein the hardware processor performs the first control by relaxing an ink amount limit value in printing of the position patch.

7. The inkjet printing apparatus according to claim 1, wherein the hardware processor performs the first control in printing of the color measurement chart performed during a normal job or between consecutive normal jobs.

8. The inkjet printing apparatus according to claim 1, wherein,
the recording medium is a printing sheet, and
the hardware processor changes an increase amount of the ink adhesion amount to the position patch relative to the ink adhesion amount to the color measurement patch in the first control, in accordance with a sheet type of the printing sheet.

9. The inkjet printing apparatus according to claim 1, wherein, in the first control, the hardware processor increases the ink adhesion amount only in edge regions on four sides of the position patch.

10. The inkjet printing apparatus according to claim 1, wherein, in the first control, the hardware processor increases the ink adhesion amount only to an edge region of the position patch in a recording medium conveyance direction.

11. The inkjet printing apparatus according to claim 1, wherein the colorimeter includes, as a position sensor that detects the position patch, a single-wavelength reflective optical fiber sensor or a reflective color sensor.

12. The inkjet printing apparatus according to claim 1, wherein the printing section prints the color measurement chart by a single-pass method.

13. The inkjet printing apparatus according to claim 1, wherein the printing section prints the color measurement chart using ultraviolet curable ink.

14. An inkjet printing method comprising:
chart printing in which a printing section prints a color measurement chart including a color measurement patch and a position patch on a recording medium; and
color measuring in which a colorimeter detects the color measurement chart,
wherein in the chart printing, a hardware processor performs first control to make an ink adhesion amount to the position patch larger than the ink adhesion amount to the color measurement patch.

15. A non-transitory computer readable storage medium comprising a program that causes a computer of an inkjet printing apparatus including a printing section that prints a color measurement chart including a color measurement patch and a position patch on a recording medium, a colorimeter that detects the color measurement chart, and a computer, to perform,
a first control to make an ink adhesion amount to the position patch larger than the ink adhesion amount to the color measurement patch in printing of the color measurement chart.
